(19) United States
(12) Patent Application Publication
(10) Pub. No.: US 2018/0365734 A1
(43) Pub. Date: Dec. 20, 2018

(54) Message System with Virtual Sensors and Telemetry

(71) Applicant: Intel Corporation, Santa Clara, CA (US)

(72) Inventors: Gabriel L. Silva, Phoenix, AZ (US); Bradut Vrabete, Sixmilebridge, Co. Clare (IE); Addicam V. Sanjay, Chandler, AZ (US)

(73) Assignee: Intel Corporation, Santa Clara, CA (US)

(21) Appl. No.: 15/622,199

(22) Filed: Jun. 14, 2017

(51) Int. Cl. G06Q 30/02

(52) U.S. Cl. CPC G06Q 30/0267

(57) ABSTRACT

An embodiment of an electronic message apparatus may include a sensor database to store information related to one or more sensors in the vicinity of a displayed message, a publish controller communicatively coupled to the sensor database to aggregate publish information including at least the sensor database information, and a transmission controller communicatively coupled to the publish controller to transmit the publish information.

### TECHNICAL FIELD

Embodiments generally relate to data collection systems. More particularly, embodiments relate to a message system with virtual sensors and telemetry.

### BACKGROUND

Traditional and/or digital signage may provide messages to viewers. Such messages may be informational or may advertise products/services. The provider of such messages may be interested in the effectiveness of the messages.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic message system according to an embodiment;

FIG. 2 is a block diagram of an example of an electronic message apparatus according to an embodiment;

FIGS. 3A to 3C are flowcharts of an example of a method of processing message-related information according to an embodiment;

FIG. 4 is a block diagram of another example of an electronic message system according to an embodiment;

FIG. 5 is a block diagram of another example of an electronic message system according to an embodiment; and

FIGS. 6A and 6B are sequence diagrams of another example of a method of processing message-related information according to an embodiment.

### DESCRIPTION OF EMBODIMENTS

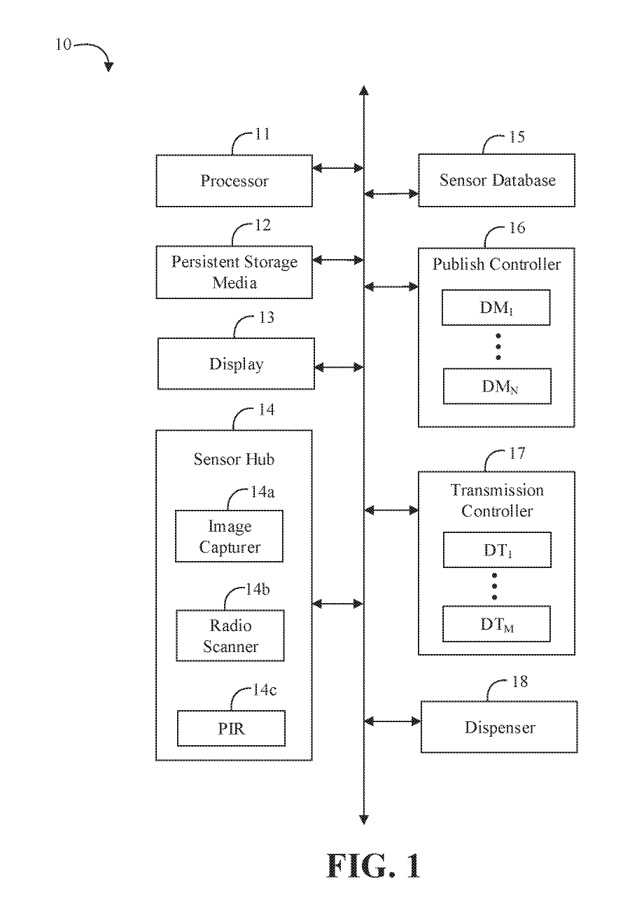

Turning now to FIG. 1, an embodiment of an electronic message system 10 may include a processor 11, persistent storage media 12 communicatively coupled to the processor 11, a display 13 communicatively coupled to the processor 11 to display a message, and a sensor hub 14 communicatively coupled to the processor 11 to sense information in the vicinity of the display. The display 13 may include any useful display device, such as a conventional mobile device display, tablet display, or other touch displays, and also simpler display devices such as numerical and digital letter displays that may present numbers or letters or a scrolling display of the same. As will be explained in greater detail, the system 10 may further include a sensor database (DB) 15 communicatively coupled to the sensor hub 14 to store information including at least the sensed information, a publish controller 16 communicatively coupled to the sensor DB 15 to aggregate publish information including at least the sensor DB information, and a transmission controller 17 communicatively coupled to the publish controller 16 to transmit the publish information.

In some embodiments, the sensor hub 14 may include one or more of an image capturer 14a to capture an image of a person in the vicinity of the display 13, a radio scanner 14b to scan for a radio signal in the vicinity of the display 13, and a passive infrared sensor (PIR) 14c to measure an amount of heat radiation in the vicinity of the display 13. In some embodiments, the publish controller 16 may include one or more data manipulators DM₁ through DMN (N>1) to manipulate the sensor DB information. In some embodiments, the transmission controller 17 may include one or more data translators DT₁ through DT_{M} (M>1) to translate the publish information for respective targets. Any of the embodiments described herein may further include a dispenser 18 communicatively coupled to the processor 11 to dispense a product. In the various embodiments described herein, various components and/or network nodes may be networked either wired or wirelessly. In particular, although many embodiments relate to wireless communication, one or more components/network nodes may be wired with electrically conducting or optical connections in any of the various embodiments described herein.

Embodiments of each of the above processor 11, persistent storage media 12, display 13, sensor hub 14, sensor DB 15, publish controller 16, data manipulators DM₁ through DMN, transmission controller 17, data translators DT₁ through DT_{M}, dispenser 18, and other system components may be implemented in hardware, software, or any suitable combination thereof. For example, hardware implementations may include configurable logic such as, for example, programmable logic arrays (PLAs), field programmable gate array (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the persistent storage media 12 may store a set of instructions which when executed by the processor 11 cause the system 10 to implement one or more components, features, or aspects of the system 10 (e.g., the sensor DB 15, the publish controller 16, the data manipulators DM₁ through DM_{N}, the transmission controller 17, the data translators DT₁ through DT_{M}, etc.).

Sensor Hub Examples

An embodiment of a sensor hub may get information from sensors, connected devices, content, services, and/or other sources to provide sensed information. The sensed information may include, for example, audio information, image information, motion information, depth information, temperature information, biometric information, CPU/GPU information, IO information, etc. For example, the sensor hub may include a sensor hub communicatively coupled to two dimensional (2D) cameras, three dimensional (3D) cameras, depth cameras, passive infrared (PIR) sensors, optical sensors, gyroscopes, accelerometers, inertial measurement units (IMUs), location services, weather services, microphones, microphone arrays, proximity sensors, weight sensors, pressure sensors, thermometers, biometric sensors, etc., and/or a combination of multiple sensors/sources. The sensor hub may be distributed across multiple devices. The information from the sensor hub may include or be combined with input data from the connected devices (e.g., smartphones, internet-of-things (IoT) devices, etc.).

The sensor hub may also include one or more virtual sensors. A virtual sensor may have no corresponding physical device. The virtual sensor may take information from two or more physical sensors or connected devices to provide determined, estimated, or predicted sensed information. The virtual sensor may additionally, or alternatively, pull data from a database. For example, rather than a physical temperature sensor to take actual temperature readings from the environment, a virtual temperature sensor may pull data from a weather service (e.g. a cloud-based service) to estimate the temperature at the location.

Some embodiments may include a machine vision system, for example, to analyze and/or perform feature/object recognition on images captured by a camera. For example, the machine vision system may be able to recognize objects such as eyeglasses, headphones, smartphones, shopping carts, strollers, etc. For example, the machine vision system may also be configured to perform facial recognition, gaze tracking, facial expression recognition, and/or gesture recognition including body-level gestures, arm/leg-level gestures, hand-level gestures, and/or finger-level gestures. The machine vision system may be configured to classify an action of the user. In some embodiments, a suitably configured machine vision system may be able to determine if the user is walking, running, sitting, standing, wearing a headset, looking at a product, looking at a display, and/or otherwise taking some other action or activity.

Sensor information collection may be completely automatic. Alternatively, a user (e.g., the provider of an advertisement or informational message) may selectively guide the information collection process. For example, the user may be presented with a screen including check boxes, pull downs, scroll lists, etc. to pick which types of information to collect. In addition, or alternatively, the provider may edit a configuration file to pick which types of information to collect. For example, the user may selectively disable information collection from particular connected sensors/devices and/or information services. Alternatively, the information collection may include a combination of automatic and manual options.

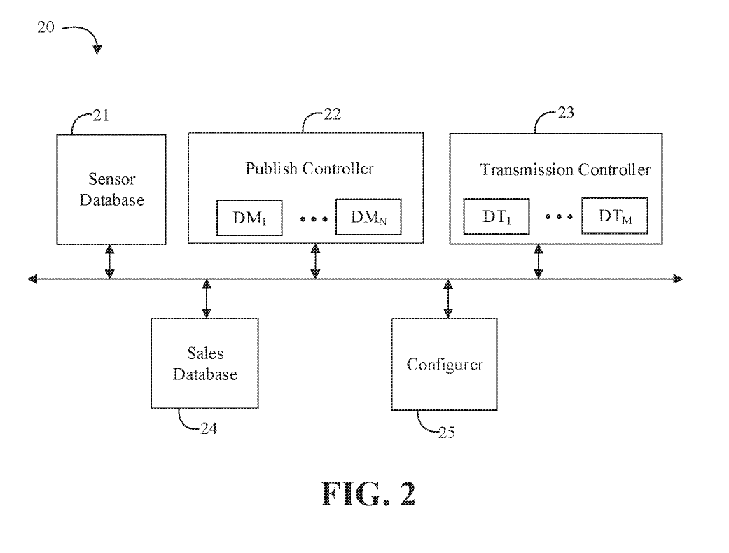

Turning now to FIG. 2, an embodiment of an electronic message apparatus 20 may include a sensor DB 21 to store information related to one or more sensors in the vicinity of a displayed message, a publish controller 22 communicatively coupled to the sensor DB 21 to aggregate publish information including at least the sensor DB information, and a transmission controller 23 communicatively coupled to the publish controller 22 to transmit the publish information. For example, the sensor DB information may include one or more of image information related to an image of a person in the vicinity of the displayed message, radio information related to a radio signal in the vicinity of the displayed message, and body heat information related to an amount of heat radiation in the vicinity of the displayed message, among other information.

In some embodiments, the publish controller 22 may include one or more data manipulators DM₁ through DM_{N} (N>1) to manipulate the sensor DB information. Some embodiments may also include a sales DB 24 to store information including one or more of sales and stock information. The publish controller 22 may be communicatively coupled to the sales DB 24 to aggregate the sales DB information with the publish information.

In some embodiments, the transmission controller may include one or more data translators DT₁ through DT_{M} (M>1) to translate the publish information for respective targets. Any of the embodiments described herein may further include a configurer 25 communicatively coupled to any of the sensor DB 21, the publish controller 22, and/or the transmission controller 23 to configure one or more of available sensor information, available data manipulators, and available data translators.

Embodiments of each of the above sensor DB 21, publish controller 22, transmission controller 23, sales DB 24, configurer 25, and other components of the apparatus 20 may be implemented in hardware, software, or any combination thereof. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Alternatively, or additionally, these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

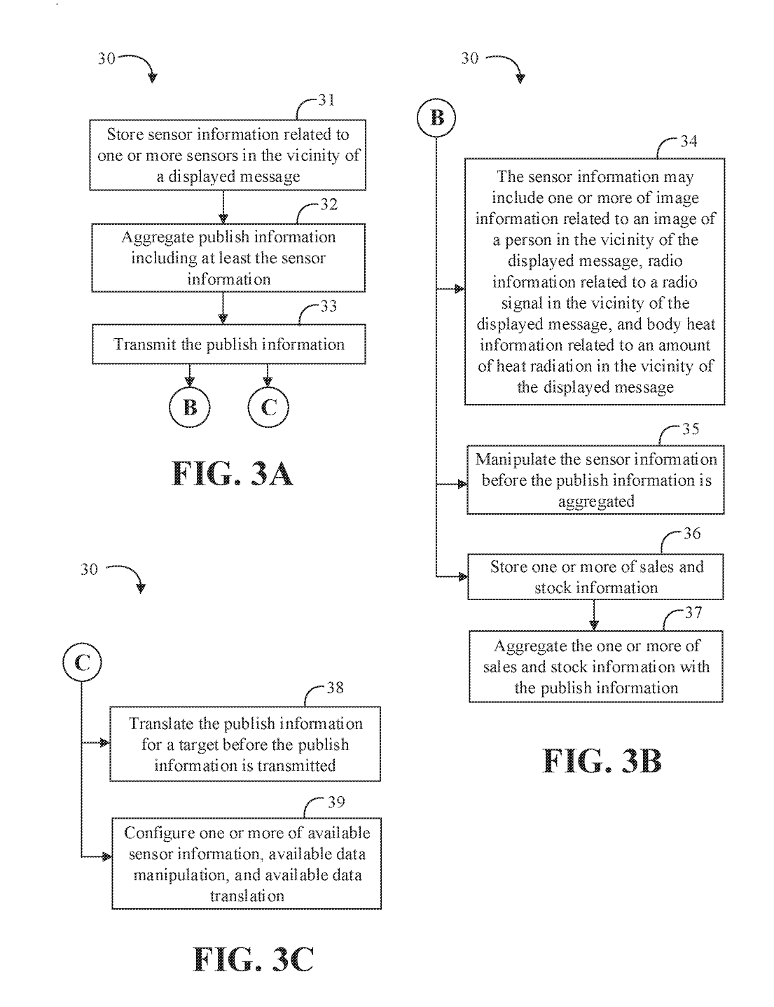

Turning now to FIG. 3, an embodiment of a method 30 of processing message-related information may include storing sensor information related to one or more sensors in the vicinity of a displayed message at block 31, aggregating publish information including at least the sensor information at block 32, and transmitting the publish information at block 33. For example, the sensor information may include one or more of image information related to an image of a person in the vicinity of the displayed message, radio information related to a radio signal in the vicinity of the displayed message, and body heat information related to an amount of heat radiation in the vicinity of the displayed message at block 34.

Some embodiments of the method 30 may further include manipulating the sensor information before the publish information is aggregated at block 35. The method 30 may also include storing one or more of sales and stock information at block 36, and aggregating the one or more of sales and stock information with the publish information at block 37. In some embodiments, the method 30 may include translating the publish information for a target protocol before the publish information is transmitted at block 38. Any of the embodiments described herein may further include configuring one or more of available sensor information, available data manipulation, and available data translation at block 39.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages. For example, the method 30 may be implemented on a computer readable medium as described in connection with Examples 19 to 24 below. For example, embodiments or portions of the method 30 may be implemented in applications (e.g., through an application programming interface (API)) or driver software running on an operating system (OS).

Advantageously, some embodiments may provide virtual sensing and telemetry. Without being limited to theory of operation, telemetry may refer to a communications process where measurements may be made and other data may be collected at remote points and transmitted to receiving equipment for evaluation. For example, some embodiments may utilize sensors, virtual sensors, wireless sensors, people counting technology, and/or facial detection to collect data at a point of sale (POS) location and apply telemetry principles to evaluate the data at another location.

An example of a suitable sensor to include in a sensor hub in accordance with some embodiments may include an INTEL AIM SUITE sensor. AIM SUITE may provide objective, quantitative measurement and analysis of what consumers are doing in retail and other spaces, all in real-time and aggregated reporting. Using anonymous sensors and highly sophisticated computer algorithms, AIM SUITE may accurately count the potential and actual audiences for visual messages and merchandising. AIM SUITE may also profile viewers by variables as broad as gender and age range, to as specific as viewing times and durations.

Some other paid advertisement systems may currently integrate with low cost cameras to detect advertisement dwell times of the audience. However, some of these solutions may be error prone and subject to double counting and/or missed counts for a variety of different scenarios. Some proprietary solutions may route their proprietary data to specific servers leaving little to no flexibility for data manipulation and/or transfer/transport optimizations at the edge and/or where that data needs to be routed or published. For example, the edge may refer to a location of the displayed message/advertisement and/or a POS location.

Advantageously, some embodiments of an electronic message system may readily add sensors (e.g., temperature sensors, wireless sensors), POS databases, plug and play libraries for data manipulation at the edge, workload distribution across edge devices, and/or finally route/publish finalized data to any cloud over any protocol as needed by customers. In accordance with some embodiments, a variety of different sensors such as BLUETOOTH scanners, WI-FI scanners, AIM SUITE sensors, REALSENSE cameras, PIR sensors, weight/pressure sensors (e.g., a sensor pad to see if someone is standing in front of display), etc. may be configured as part of a flexible telemetry system to achieve more insights from the data at the edge. The data may also be sent efficiently to the customer's cloud of choice for more analysis.

Some embodiments may be better understood with reference to some non-limiting use case examples. In one example use case, a retail customer may collect POS data from X vending machines (e.g., where X>0) and may estimate the number of people near a vending machine people via a BLUETOOTH scanner, a WI-FI scanner, and a camera. The camera may capture the age, gender, and the dwell time of the people who appear to be actually looking at the advertisements (although the camera may sometimes double count and/or miss counts). The BLUETOOTH and WI-FI scanners may capture the number of unique radio signals from people near the vending. For example, a wireless network card may attempt to identify nearby signals and may receive a unique identification number associated with the transmitter (e.g., for possible connecting/pairing). The scanners may also measure signal strength and utilize a threshold to determine whether a radio signal is from a nearby person. Some embodiments may advantageously combine the sales data, camera data, and wireless sensor data to learn and adjust sales and advertisement effectiveness.

In another example use case, a retail customer (e.g., a micro-market) may collect people-count data from cameras, WI-FI, BLUETOOTH, and PIR sensors. People-count data from the camera may be dependent on lighting, distance of a person from the camera, number of people present, and other factors. These factors may impact the accuracy of the people counting capability of the camera alone. However, adding other sensors to scan for BLUETOOTH and WI-FI devices may collect unique counts of radio signals from the detected people. Adding PIR sensors may collect additional body heat information to determine the presence of people and to count people. Advantageously, some embodiments may combine the data to get better insight of the surrounding audience.

In another example use case, a customer may pay for data transmission and/or may pay per use for web services. A retail customer may collect camera, WI-FI, and BLUETOOTH people counts, and may also collect audience demographic data. The customer may summarize the data into a single message for all three sensors, compress the data, and publish the compressed, summarized to their web service. Advantageously, some embodiments may reduce the amount of data transmitted and/or the number of uses of the web service to save the customer money.

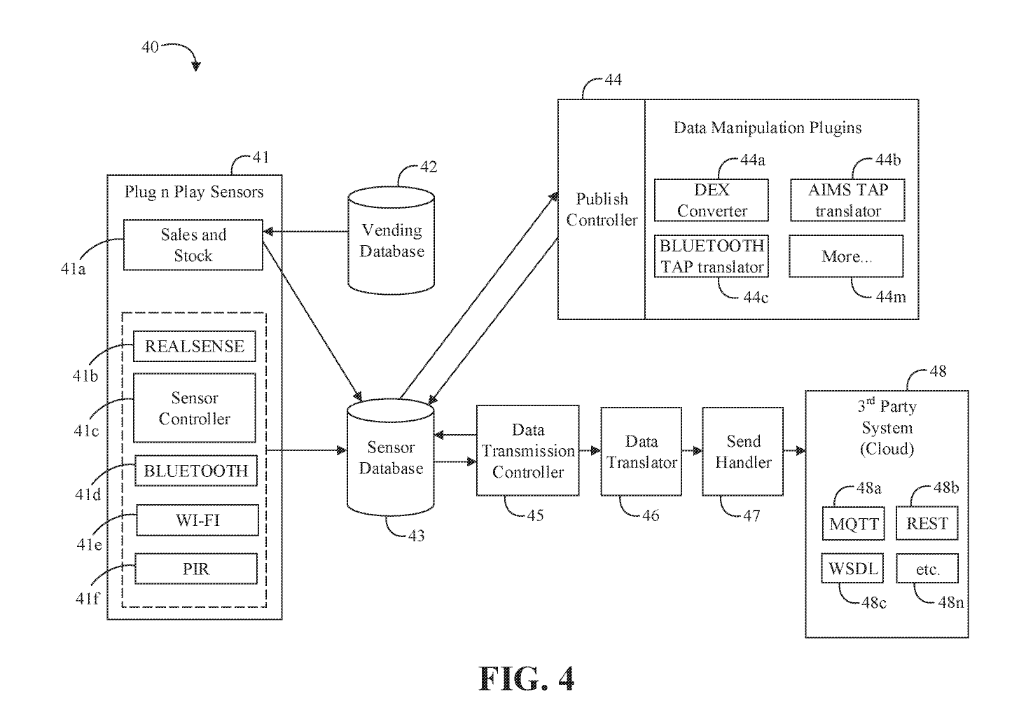

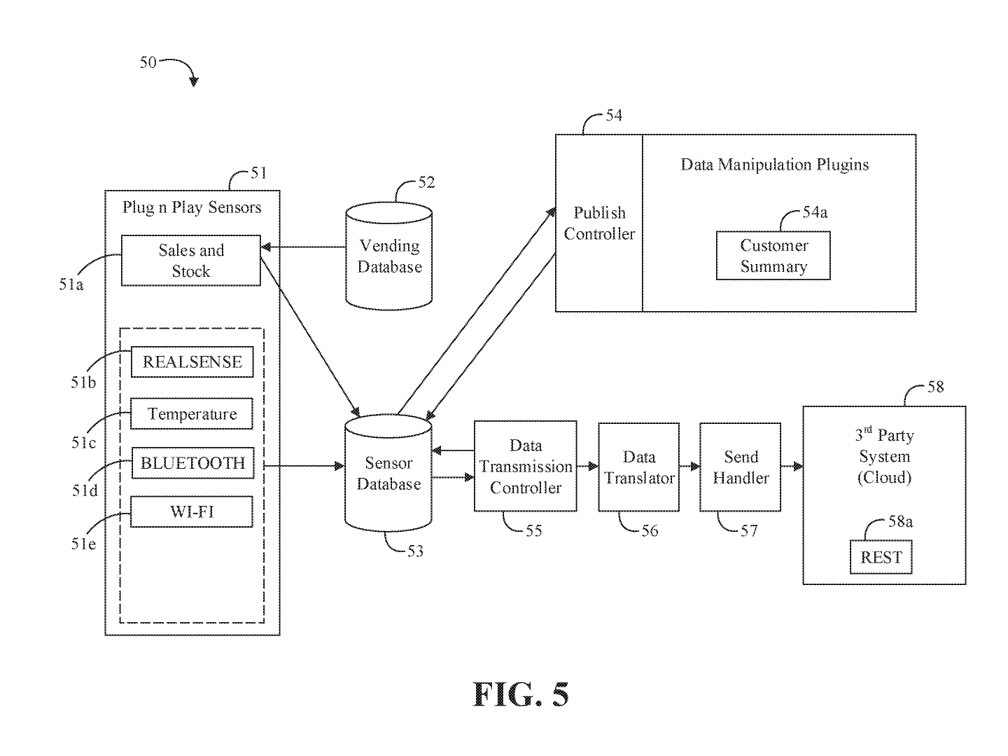

Turning now to FIG. 4, an embodiment of an electronic messaging system 40 may include one or more plug and play sensors 41. For example, the sensors 41 may include sales and stock sensors 41a, REALSENSE sensors 41b, a sensor controller 41c, BLUETOOTH sensors 41d, WI-FI sensors 41e, and PIR sensors 41f. The sales and stock sensors 41a may pull information from a vending DB 42 and provide information to a sensor DB 43. One or more of the other sensors 41 may provide information to the sensor DB 43. The system 40 may also include a publish controller 44 to aggregate information from the sensor DB 43 to generate a publish table. For example, the publish controller 44 may include one or more data manipulation plug-ins 44a through 44m to manipulate information pulled from the sensor DB 43. In some embodiments, the publish controller 44 may include a data exchange (DEX, a vending machine standard) converter plug-in 44a, an AIMS trusted analytics platform (TAP) translator plug-in 44b, a BLUETOOTH TAP translator plug-in 44c, etc.

The converted data from each of the data manipulation plug-ins may be included in the publish table which, in some embodiments, may be stored back in the sensor DB 43. The system 40 may further include a data transmission controller 45 coupled to the sensor DB 43 to control transmission of the publish table. For example, the data transmission controller 45 may provide the publish table to one or more data translators 46 to translate the publish table into an appropriate format for one or more target systems. A send handler 47 may get the translated publish table(s) from the data translators 46 to send the translated data to one or more target systems 48. For example, the target systems 48 may include one or more third party systems such as an MQ telemetry transport (MQTT)-based system 48a, a representational state transfer (REST)-based system 48b, a web-services description language (WSDL)-based 48c, through an Nth target system 48n. In some embodiments, one or more of the targets may include private or proprietary networks/servers/systems.

In an example use case for the system 40, each module may contain an in-memory database to store local data. The sensor 41a may read the vending DB 42 for sales, stock, and event data, and then update the sensor DB 43 with sales and stock information. The various other sensor modules may write data into the sensor DB 43. For example, the sensor DB 43 may store information related to 1) people count from a REALSENSE application; 2) sensor data read from a vending machine controller (VMC); 3) BLUETOOTH data; 4) WI-FI data; 5) PIR data; and 6) the publish table. The publish controller 44 may read PIR, WI-FI, BLUETOOTH, REALSENSE, other sensor information, stock and sales information from the sensor DB 43 and utilize the available data manipulation plug-ins to process the data and convert the results into JAVASCRIPT object notation (JSON) format (e.g., or another standard format such as extensible markup language (XML)). The publish controller 44 may then write the JSON format data in the publish table of the sensor DB 43. For example, the publish controller 44 may read the sensor DB 43 at a configured interval, and thereafter convert the manipulated data to JSON and store the results in the publish table. The data transmission controller 45 may periodically read the publish table from the sensor DB 43, translate the publish table as needed and send it to the target systems. After the publish table is confirmed to be successfully sent, the publish table may be updated with an “isSent” flag.

Turning now to FIG. 5, an embodiment of an electronic messaging system 50 may include one or more plug and play sensors 51. For example, the sensors 51 may include sales and stock sensors 51a, REALSENSE sensors 51b, temperature sensors 51c, BLUETOOTH sensors 51d, and WI-FI sensors 51e. The sales and stock sensors 51a may pull information from a vending DB 52 and provide information to a sensor DB 53. One or more of the other sensors 51 may provide information to the sensor DB 53. The system 50 may also include a publish controller 54 to aggregate information from the sensor DB 53 to generate a publish table. For example, the publish controller 54 may include a customer summary plug-in 54a to summarize information pulled from the sensor DB 53. In some embodiments, the publish controller 54 may include additional data manipulation plug-ins.

The summarized data may be included in the publish table which, in some embodiments, may be stored back in the sensor DB 53. The system 50 may further include a data transmission controller 55 coupled to the sensor DB 53 to control transmission of the publish table. For example, the data transmission controller 55 may provide the publish table to one or more data translators 56 to translate the publish table into an appropriate format for one or more target systems. A send handler 57 may get the translated publish table(s) from the data translators 56 to send the translated data to a target system 58. For example, the target system 58 may include a REST-based system 58a. For example, the target system 58 may include a commercially hosted web service such as Amazon Web Services (AWS). In some embodiments, the target system 58 may include additional target formats/protocols/systems.

In an example use case, the system 50 may be an advertisement station. For example, the advertisement station may show the products themselves (e.g., visible through glass), and may also include electronic display devices for advertising content. Alternatively, the advertisement station may not show the products and may instead include a large, front facing electronic display to display images of the products and/or advertising. In some installations, the advertisement station may be remote to the actual products/services being advertised. The sensor 51a may read the vending DB 52 for sales, stock, and event data, and then update the sensor DB 53 with sales and stock information. The various other sensor modules may also write data into the sensor DB 53. The WI-FI and BLUETOOTH sensors 51e, 51d may scan for people who are near the advertisement station. The REALSENSE camera may count people who are viewing the advertisement (e.g., and may save other user information) from the advertisement station. Temperature data from the temperature sensor 51c may be saved at the time of the BLUETOOTH, WI-FI, and REALSENSE scans. Sales information may also be saved at the time of the sensor readings. The publish controller 54 may read the sensor DB 53 at a configured interval. The customer summary data manipulation plug-in 54a may combine the REALSENSE, Temperature, BLUETOOTH, WI-FI, and sales information and may convert the combined results into JSON format for the publish table. The data transmission controller 55 may read the publish table at a configured interval from the sensor DB 43, translate the publish table as needed and send it to the target system. After the publish table is confirmed to be successfully sent, the publish table may be updated with an “isSent” flag. For example, the publish table, including the customer summary data, may be sent to an AWS hosted cloud via REST services. Thereafter, the customer may evaluate the advertisement effectiveness based on the data from the publish table.

Some edge devices (e.g., a vending machine) may have a low data limit (e.g., less than 1 GB per month) and/or a low bandwidth 3G cellular network connection. After all of the data has been collected, a summary report may advantageously make efficient use of resources (e.g., time, bandwidth, money) as compared to sending all the data points to the cloud.

Advantageously, some embodiments may provide a flexibly telemetry system that may improve or optimize people counting with a variety of wireless, camera, IR sensors, and/or other sensors. Some embodiments may provide flexible processing at the edge and may provide more processing power in an edge gateway to infer better insights from multiple data streams and sensors. For example, a person may carry one device, but have multiple radios (e.g., BLUETOOTH, WI-FI, near field communication (NFC), radio frequency identification (RFID), etc.). Alternatively, or in addition, a person may carry multiple devices, each having one or more radios (e.g., phone with BLUETOOTH and NFC, tablet with WI-FI, e-reader with BLUETOOTH and WI-FI, etc.). A single person who should count as one may be multiple counted based solely on radio signals. Wireless scanning may overcount because it can detect through walls, multiple layers of people, etc. For example, a camera may capture an image of a single person. Camera counting may only count unobstructed images of people in front of the advertising. Camera counting may also include image recognition to determine if a person in front of the advertising is looking at the products/displays. Additional sensors may indicate the presence of one person associated with all the radio signals. PIR may register body heat from a single person. A pressure mat may identify just one person standing on the mat. The temperature data may be included for later evaluation of correlations between temperature, advertising, and sales. Additional data points provided by some embodiments may provide more or better information for the customer to evaluate the effectiveness of the message. For example, the customer may restock based on sales, may correlate sales to the various people counts (WI-FI, BLUETOOTH, REALSENSE, PIR, AIM SUITE, etc.), may correlate sales to ambient temperature, etc.

In some embodiments, the edge device may be considered as a gateway device. The gateway may be a POS location, or any other useful device for collecting/processing data before sending the data to the cloud. In some embodiments, the edge device may be associated with traditional signage or digital signage. For example, a display may be at one end of a shopping center while the store/products advertised may be at another end of the shopping center. The signage may also be informational and the provider of the information may want to evaluate the effectiveness of the signage (e.g., for a safety message informing people about a hazard such as a construction site).

Referring to FIGS. 4 and 5, the targets 48, 58 may include one or more other edge/gateway devices as target systems. Several edge devices may be interconnected with only a subset or one of the edge devices having the cloud connection. For example, a retailer may have several kiosks at each terminal of an airport which may communicate to each other over a local area network (LAN) while only one of the kiosks may include a cellular radio to upload data. In some embodiments, workload may be distributed among the connected gateway devices. For example, data manipulation for the publish table may be performed on one gateway device while data translation prior to transmission may be performed on another gateway device.

Some embodiments may include most/all components self-contained within a housing at the edge device (e.g., a stand-alone vending machine) or may be distributed (e.g., sensors provided at a POS location while other components may be provided in connected compute device). Alternatively, the sensors may be near the displayed message, but the remainder of system may be remote as long as the system is in communication with the sensors or can collect the sensor data.

Some embodiments may advantageously provide a highly configurable, expandable, and extensible electronic message system. For example, some embodiments may collect more information at a POS and provide an option to do more analysis and to summarize the data before uploading to the cloud. In some embodiments, the sensors may be plug-and-play, the data manipulation may be provided by plug-ins, the data translators may be provided by plug-ins, etc. Advantageously, the customer may configure the station as needed. The customer may create one or more targeted plug-ins at the edge to collect the needed data, summarize the data, and upload the data for further evaluation. Some embodiments may provide flexibility for the data collected, analyzed, and sent and may support future innovations for the customer (e.g., new data collection and analysis techniques).

In some embodiments, a configuration file may identify respective plug-ins for a wide variety of sensors. The customer may edit the configuration file to enable the available/desired sensors for a particular configuration. A new plug-in may be built to add a new sensor to the configuration and the configuration file may be updated to include the new plug-in for the new sensor. For example, the sensor plug-ins may be contained in a library file such as a dynamic link library (DLL). For example, the publish controller may examine the configuration file to determine which sensors are active. The configuration file may also identify which data manipulation plug-ins are available and enabled or disabled.

In one use case, the system may provide a library for a customer summary that may be enabled. That library may include logic to look at the relevant databases and merge/summarize the data. The publish controller may periodically look for updates to the data, convert the data as needed, summarize the data, and then stage the results in another table for transmission (e.g., a publish table stored in the sensor DB).

The components/parameters of the data transmission controller (DTC) may also be determined by information in the configuration file. The DTC may look in the publish table and may reformat the publish table as needed for one or more target systems. If the communication fails, the DTC may retry until the communication is successful. The DTC may guarantee delivery of the data in the required format.

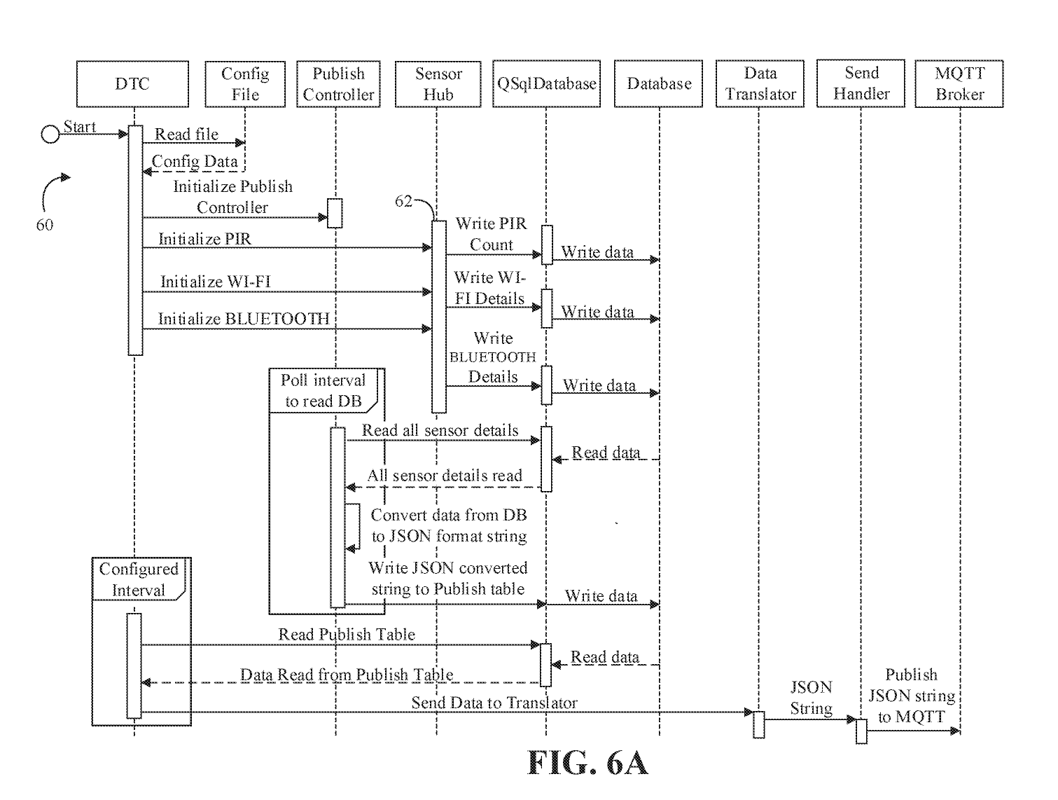

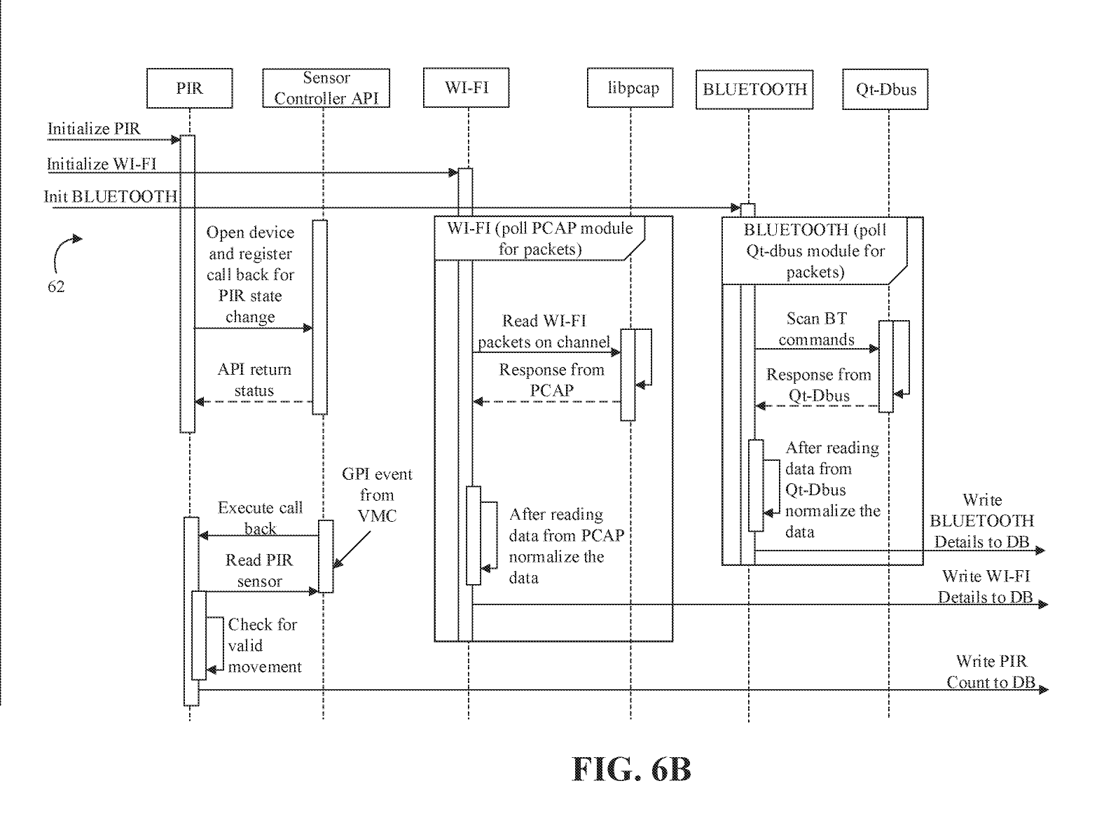

Turning now to FIGS. 6A to 6B, an example sequence diagram may show an illustrative processing sequence 60 in accordance with some embodiments. The DTC may read data from a configuration file and use the configuration to initialize the publish controller, the PIR sensor(s), the WI-FI sensor(s), the BLUETOOTH sensor(s), etc. A sensor hub may collect data and write counts, details, and other data to a DB via a QSqlDatabase connection. The publish controller may read the DB at a poll interval set in the configuration file. The publish controller may convert data from the DB to JSON format and write the JSON formatted data to a publish table in the DB. The DTC may read the publish table at a configured interval and send the data to a translator. The translated JSON data may be provided to a send handler to publish the translated JSON data to a MQTT broker.

An example sequence 62 for the sensor hub may initialize the PIR sensor(s), open the device, and register a call back for a PIR state change with a sensor controller. A general purpose interrupt (GPI) event from a VMC may execute a call back where the PIR sensor is read. If a check determines a valid movement, a PIR count may be written to the DB (e.g., along with a date/time stamp). The sequence 62 may include initializing the WI-FI sensor(s) and then using the libpcap (a portable C/C++ library for network traffic capture) routines to read WI-FI packets on a channel. After reading data from PCAP (packet capture), the data may be normalized and the WI-FI details may be written to the DB. Similarly, the sequence may initialize the BLUETOOTH sensor(s) and then poll the Qt-Dbus module for packets. The BLUETOOTH sensor(s) may scan for BLUETOOTH commands and read a response from the Qt-Dbus. After reading data from the Qt-Dbus, the data may be normalized and the BLUETOOTH details may be written to the DB.

### ADDITIONAL NOTES AND EXAMPLES

Example 1 may include an electronic message system, comprising a processor, persistent storage media communicatively coupled to the processor, a display communicatively coupled to the processor to display a message, a sensor hub communicatively coupled to the processor to sense information in the vicinity of the display, a sensor database communicatively coupled to the sensor hub to store information including at least the sensed information, a publish controller communicatively coupled to the sensor database to aggregate publish information including at least the sensor database information, and a transmission controller communicatively coupled to the publish controller to transmit the publish information.

Example 2 may include the system of Example 1, wherein the sensor hub includes one or more of an image capturer to capture an image of a person in the vicinity of the display, a radio scanner to scan for a radio signal in the vicinity of the display, and a passive infrared sensor to measure an amount of heat radiation in the vicinity of the display.

Example 3 may include the system of Example 1, wherein the publish controller includes one or more data manipulators to manipulate the sensor database information.

Example 4 may include the system of Example 1, wherein the transmission controller includes one or more data translators to translate the publish information for respective targets.

Example 5 may include the system of any of Examples 1 to 4, further comprising a dispenser communicatively coupled to the processor to dispense a product.

Example 6 may include the system of any of Examples 1 to 4, wherein the display includes one or more of a numerical display device and a digital letter display device.

Example 7 may include an electronic message apparatus, comprising a sensor database to store information related to one or more sensors in the vicinity of a displayed message, a publish controller communicatively coupled to the sensor database to aggregate publish information including at least the sensor database information, and a transmission controller communicatively coupled to the publish controller to transmit the publish information.

Example 8 may include the apparatus of Example 7, wherein the sensor database information includes one or more of image information related to an image of a person in the vicinity of the displayed message, radio information related to a radio signal in the vicinity of the displayed message, and body heat information related to an amount of heat radiation in the vicinity of the displayed message.

Example 9 may include the apparatus of Example 7, wherein the publish controller includes one or more data manipulators to manipulate the sensor database information.

Example 10 may include the apparatus of Example 9, further comprising a sales database to store information including one or more of sales and stock information, wherein the publish controller is communicatively coupled to the sales database to aggregate the sales database information with the publish information.

Example 11 may include the apparatus of Example 7, wherein the transmission controller includes one or more data translators to translate the publish information for respective targets.

Example 12 may include the apparatus of any of Examples 7 to 11, further comprising a configurer communicatively coupled to the sensor database, the publish controller, and the transmission controller to configure one or more of available sensor information, available data manipulators, and available data translators.

Example 13 may include a method of processing message-related information, comprising storing sensor information related to one or more sensors in the vicinity of a displayed message, aggregating publish information including at least the sensor information, and transmitting the publish information.

Example 14 may include the method of Example 13, wherein the sensor information includes one or more of image information related to an image of a person in the vicinity of the displayed message, radio information related to a radio signal in the vicinity of the displayed message, and body heat information related to an amount of heat radiation in the vicinity of the displayed message.

Example 15 may include the method of Example 13, further comprising manipulating the sensor information before the publish information is aggregated.

Example 16 may include the method of Example 15, further comprising storing one or more of sales and stock information, and aggregating the one or more of sales and stock information with the publish information.

Example 17 may include the method of Example 13, further comprising translating the publish information for a target protocol before the publish information is transmitted.

Example 18 may include the method of any of Examples 13 to 17, further comprising configuring one or more of available sensor information, available data manipulation, and available data translation.

Example 19 may include at least one computer readable medium, comprising a set of instructions, which when executed by a computing device, cause the computing device to store sensor information related to one or more sensors in the vicinity of a displayed message, aggregate publish information including at least the sensor information, and transmit the publish information.

Example 20 may include the at least one computer readable medium of Example 19, wherein the sensor information includes one or more of image information related to an image of a person in the vicinity of the displayed message, radio information related to a radio signal in the vicinity of the displayed message, and body heat information related to an amount of heat radiation in the vicinity of the displayed message.

Example 21 may include the at least one computer readable medium of Example 19, comprising a further set of instructions, which when executed by a computing device, cause the computing device to manipulate the sensor information before the publish information is aggregated.

Example 22 may include the at least one computer readable medium of Example 21, comprising a further set of instructions, which when executed by a computing device, cause the computing device to store one or more of sales and stock information, and aggregate the one or more of sales and stock information with the publish information.

Example 23 may include the at least one computer readable medium of Example 19, comprising a further set of instructions, which when executed by a computing device, cause the computing device to translate the publish information for a target protocol before the publish information is transmitted.

Example 24 may include the at least one computer readable medium of any of Examples 19 to 23, comprising a further set of instructions, which when executed by a computing device, cause the computing device to configure one or more of available sensor information, available data manipulation, and available data translation.

Example 25 may include an electronic message apparatus, comprising means for storing sensor information related to one or more sensors in the vicinity of a displayed message, means for aggregating publish information including at least the sensor information, and means for transmitting the publish information.

Example 26 may include the apparatus of Example 25, wherein the sensor information includes one or more of image information related to an image of a person in the vicinity of the displayed message, radio information related to a radio signal in the vicinity of the displayed message, and body heat information related to an amount of heat radiation in the vicinity of the displayed message.

Example 27 may include the apparatus of Example 25, further comprising means for manipulating the sensor information before the publish information is aggregated.

Example 28 may include the apparatus of Example 27, further comprising means for storing one or more of sales and stock information, and means for aggregating the one or more of sales and stock information with the publish information.

Example 29 may include the apparatus of Example 25, further comprising means for translating the publish information for a target protocol before the publish information is transmitted.

Example 30 may include the apparatus of any of Examples 25 to 29, further comprising means for configuring one or more of available sensor information, available data manipulation, and available data translation.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic message system, comprising:
a processor;
persistent storage media communicatively coupled to the processor;
a display communicatively coupled to the processor to display a message;
a sensor hub communicatively coupled to the processor to sense information in the vicinity of the display;
a sensor database communicatively coupled to the sensor hub to store information including at least the sensed information;
a publish controller communicatively coupled to the sensor database to aggregate publish information including at least the sensor database information; and
a transmission controller communicatively coupled to the publish controller to transmit the publish information.

2. The system of claim 1, wherein the sensor hub includes one or more of an image capturer to capture an image of a person in the vicinity of the display, a radio scanner to scan for a radio signal in the vicinity of the display, and a passive infrared sensor to measure an amount of heat radiation in the vicinity of the display.

3. The system of claim 1, wherein the publish controller includes one or more data manipulators to manipulate the sensor database information.

4. The system of claim 1, wherein the transmission controller includes one or more data translators to translate the publish information for respective targets.

5. The system of claim 1, further comprising:
a dispenser communicatively coupled to the processor to dispense a product.

6. The system of claim 1, wherein the display includes one or more of a numerical display device and a digital letter display device.

7. An electronic message apparatus, comprising:
a sensor database to store information related to one or more sensors in the vicinity of a displayed message;
a publish controller communicatively coupled to the sensor database to aggregate publish information including at least the sensor database information; and
a transmission controller communicatively coupled to the publish controller to transmit the publish information.

8. The apparatus of claim 7, wherein the sensor database information includes one or more of image information related to an image of a person in the vicinity of the displayed message, radio information related to a radio signal in the vicinity of the displayed message, and body heat information related to an amount of heat radiation in the vicinity of the displayed message.

9. The apparatus of claim 7, wherein the publish controller includes one or more data manipulators to manipulate the sensor database information.

10. The apparatus of claim 9, further comprising:
a sales database to store information including one or more of sales and stock information, wherein the publish controller is communicatively coupled to the sales database to aggregate the sales database information with the publish information.

11. The apparatus of claim 7, wherein the transmission controller includes one or more data translators to translate the publish information for respective targets.

12. The apparatus of claim 7, further comprising:
a configurer communicatively coupled to the sensor database, the publish controller, and the transmission controller to configure one or more of available sensor information, available data manipulators, and available data translators.

13. A method of processing message-related information, comprising:
storing sensor information related to one or more sensors in the vicinity of a displayed message;
aggregating publish information including at least the sensor information; and
transmitting the publish information.

14. The method of claim 13, wherein the sensor information includes one or more of image information related to an image of a person in the vicinity of the displayed message, radio information related to a radio signal in the vicinity of the displayed message, and body heat information related to an amount of heat radiation in the vicinity of the displayed message.

15. The method of claim 13, further comprising:
manipulating the sensor information before the publish information is aggregated.

16. The method of claim 15, further comprising:
storing one or more of sales and stock information; and
aggregating the one or more of sales and stock information with the publish information.

17. The method of claim 13, further comprising:
translating the publish information for a target protocol before the publish information is transmitted.

18. The method of claim 13, further comprising:
configuring one or more of available sensor information, available data manipulation, and available data translation.

19. At least one computer readable medium, comprising a set of instructions, which when executed by a computing device, cause the computing device to:
store sensor information related to one or more sensors in the vicinity of a displayed message;
aggregate publish information including at least the sensor information; and
transmit the publish information.

20. The at least one computer readable medium of claim 19, wherein the sensor information includes one or more of image information related to an image of a person in the vicinity of the displayed message, radio information related to a radio signal in the vicinity of the displayed message, and body heat information related to an amount of heat radiation in the vicinity of the displayed message.

21. The at least one computer readable medium of claim 19, comprising a further set of instructions, which when executed by a computing device, cause the computing device to:
manipulate the sensor information before the publish information is aggregated.

22. The at least one computer readable medium of claim 21, comprising a further set of instructions, which when executed by a computing device, cause the computing device to:
store one or more of sales and stock information; and
aggregate the one or more of sales and stock information with the publish information.

23. The at least one computer readable medium of claim 19, comprising a further set of instructions, which when executed by a computing device, cause the computing device to:
translate the publish information for a target protocol before the publish information is transmitted.

24. The at least one computer readable medium of claim 19, comprising a further set of instructions, which when executed by a computing device, cause the computing device to:
configure one or more of available sensor information, available data manipulation, and available data translation.
